(19) United States
(12) Patent Application Publication
(10) Pub. No.: US 2026/0229066 A1
(43) Pub. Date: Aug. 6, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Ryoma OAMI, Tokyo (JP); Masato SASAKI, Tokyo (JP); Kosuke YOSHIMI, Tokyo (JP); Ryo YAMAKABE, Tokyo (JP); Megumi HASHIMOTO, Tokyo (JP); Shinji OOMINATO, Tokyo (JP); Yoshihiro KAJIKI, Tokyo (JP)

(73) Assignee: NEC Corporation, Tokyo (JP)

(21) Appl. No.: 19/152,972

(22) PCT Filed: Feb. 10, 2023
(86) PCT No.: PCT/JP2023/004618

§ 371 Date: Aug. 1, 2025

(51) Int. Cl. G06V 40/70; G06F 21/32; G06V 40/16; G06V 40/18

(52) U.S. Cl. CPC G06V 40/70; G06F 21/32; G06V 40/172; G06V 40/197

(57) ABSTRACT

An information processing apparatus includes: a facial recognition unit that performs facial recognition by using a face image including a face of a target; an iris recognition unit that performs iris recognition by using an eye image including an iris of the target; and a determination unit that performs identity determination of determining whether the target is a registered person himself/herself, based on a result of the facial recognition and a result of the iris recognition. The determination unit lowers priority of the iris recognition and performs the identity determination, in a case where it is estimated by using information about the target that the target is in a state of at least one of crying and having teary eyes.

### TECHNICAL FIELD

The present disclosure relates to technical fields of an information processing apparatus, an information processing method, and a recording medium.

### BACKGROUND ART

For example, there is proposed a multimodal biometric authentication apparatus that acquires images of a face and veins by using a common imaging unit and performs facial recognition using a face image and vein authentication using a vein pattern (see Patent Literature 1).

### CITATION LIST

### Patent Literature

### Patent Literature 1: JP2008-217358A

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect includes: a facial recognition unit that performs facial recognition by using a face image including a face of a target; an iris recognition unit that performs iris recognition by using an eye image including an iris of the target; and a determination unit that performs identity determination of determining whether the target is a registered person himself/herself, based on a result of the facial recognition and a result of the iris recognition, wherein the determination unit lowers priority of the iris recognition and performs the identity determination, in a case where it is estimated by using information about the target that the target is in a state of at least one of crying and having teary eyes.

An information processing method according to an example aspect includes: performing facial recognition by using a face image including a face of a target; performing iris recognition by using an eye image including an iris of the target; performing identity determination of determining whether the target is a registered person himself/herself, based on a result of the facial recognition and a result of the iris recognition; and lowering priority of the iris recognition and performing the identity determination, in a case where it is estimated by using information about the target that the target is in a state of at least one of crying and having teary eyes.

A recording medium according to an example aspect is a recording medium on which a computer program that allows a computer to execute an information processing method is recorded, the information processing method including: performing facial recognition by using a face image including a face of a target; performing iris recognition by using an eye image including an iris of the target; performing identity determination of determining whether the target is a registered person himself/herself, based on a result of the facial recognition and a result of the iris recognition; and lowering priority of the iris recognition and performing the identity determination, in a case where it is estimated by using information about the target that the target is in a state of at least one of crying and having teary eyes.

### BRIEF DESCRIPTION OF DRAWINGS

FIG. 1 is a block diagram illustrating an example of an information processing apparatus.

FIG. 2 is a block diagram illustrating another example of the information processing apparatus.

FIG. 3 is a block diagram illustrating another example of the information processing apparatus.

FIG. 4 is a diagram illustrating an example of a near-infrared camera.

FIG. 5 is a diagram illustrating another example of the near-infrared camera.

FIG. 6 is a block diagram illustrating another example of the information processing apparatus.

FIG. 7 is a block diagram illustrating another example of the information processing apparatus.

### DESCRIPTION OF EXAMPLE EMBODIMENTS

An information processing apparatus, an information processing method, and a recording medium according to example embodiments will be described with reference to the drawings.

### First Example Embodiment

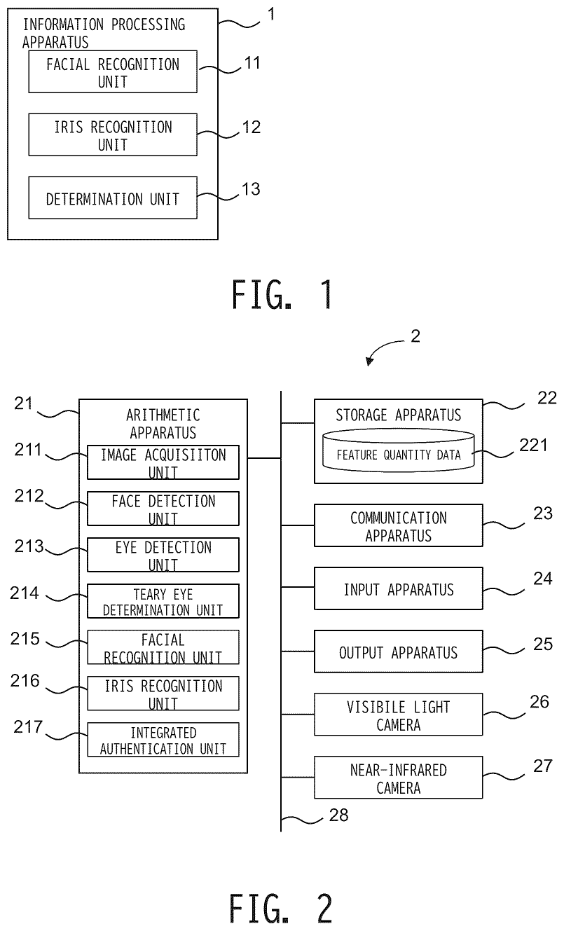

An information processing apparatus, an information processing method, and a recording medium according to a first example embodiment will be described with reference to FIG. 1. The following describes the information processing apparatus, information processing method, and recording medium according to the first example embodiment, by using an information processing apparatus 1.

In FIG. 1, the information processing apparatus 1 is provided with a facial recognition unit 11, an iris recognition unit 12, and a determination unit 13. The facial recognition unit 11 performs facial recognition by using a face image including a face of a target person. The iris recognition unit 12 performs iris recognition by using an eye image including an iris of the target person. The face image may be an image generated by imaging the face of the target person with a camera including a light receiving element that is configured to receive visible light. The eye image may be an image generated by imaging eyes of the target person with a camera including a light receiving element that is configured to receive near-infrared light. Since various existing methods are applicable to the facial recognition and the iris recognition, a description of details thereof is omitted.

The determination unit 13 may perform identity determination/verification of determining whether or not the target person is a registered person himself/herself, based on a result of the facial recognition by the facial recognition unit 11 and a result of the iris recognition by the iris recognition unit 12. That is, the information processing apparatus 1 may perform multimodal biometric authentication in which the facial recognition and the iris recognition are combined. The determination unit 13 may perform the identity determination of determining whether or not the target person is the registered person himself/herself, based on one of the result of the facial recognition by the facial recognition unit 11 and the result of the iris recognition by the iris recognition unit 12. That is, the information processing apparatus 1 may perform single-modal biometric authentication using the facial recognition or the iris recognition.

For example, when a foreign object such as pollen gets into the eye, a lot of tears are secreted to wash away the foreign object. For example, when a child is crying, a lot of tears are secreted. As described above, when the eye of the target person is covered with a relatively large amount of moisture (e.g., tears), especially when an iris area of the eye of the target person is covered with moisture, the iris recognition of the target person is likely to be failed. In addition, in at least one of the cases where the foreign object gets into the eye and where a child is crying, eye opening is smaller. In particular, when the iris area of the eye of the target person is covered with moisture, the eye opening is smaller than that when the foreign object gets into the eye and where a child is crying. As a result, the iris area included in the eye image becomes smaller, thereby making the iris recognition more likely to be failed.

In view of the above technical problems, in the information processing apparatus 1, in a case where it is estimated by using information about the target person that the target person is in a state of at least one of crying and having teary eyes, the determination unit 13 lowers priority of the iris recognition and performs the above identity determination. For example, even when the iris recognition is failed, in a case where the facial recognition is successful, the determination unit 13 may determine that the target person is the registered person himself/herself. The information about the target person may include at least one of the face image including the face of the target person and the eye image including the iris of the target person.

In the information processing apparatus 1 configured as described above, it can be said that performed is an information processing method including: performing facial recognition by using a face image including a face of a target; performing iris recognition by using an eye image including an iris of the target; performing identity determination of determining whether the target is a registered person himself/herself, based on a result of the facial recognition and a result of the iris recognition; and lowering priority of the iris recognition and performing the identity determination, in a case where it is estimated by using information about the target that the target is in a state of at least one of crying and having teary eyes.

The information processing apparatus 1 may be realized, for example, by a computer reading a computer program recorded on a recording medium. In this case, it can be said that a computer program that allows a computer to execute an information processing method is recorded on a recording medium, the information processing method including: performing facial recognition by using a face image including a face of a target; performing iris recognition by using an eye image including an iris of the target; performing identity determination of determining whether the target is a registered person himself/herself, based on a result of the facial recognition and a result of the iris recognition; and lowering priority of the iris recognition and performing the identity determination, in a case where it is estimated by using information about the target that the target is in a state of at least one of crying and having teary eyes.

### Technical Effect

For example, in a case where a resident entering his/her residence is managed by the multimodal biometric authentication in which the facial recognition and the iris recognition are combined, a child who is a resident may fail in the multimodal biometric authentication and may thus start crying. As a result, the iris recognition of the child may become harder, and the child may repeatedly fail in the multimodal biometric authentication. For example, pollen may get into the eyes of a target person suffering from hay fever, causing the eyes to secrete a lot of tears. As a result, the iris recognition of the target person may become harder, and the target person may fail in the multimodal biometric authentication. If no measures are taken against such cases, user convenience is reduced. However, in the information processing apparatus 1, in a case where it is estimated that the target person of the biometric authentication is in a state of at least one of crying and having teary eyes, the determination unit 13 lowers the priority of the iris recognition and performs the above identity determination. For this reason, according to the information processing apparatus 1, even when the target person is in a state of at least one of crying and having teary eyes, the identity determination may be performed appropriately. Therefore, according to the information processing apparatus 1, it is possible to prevent/control a reduction in the user convenience.

### Second Example Embodiment

An information processing apparatus, an information processing method, and a recording medium according to a second example embodiment will be described with reference to FIG. 2. The following describes the information processing apparatus, information processing method, and recording medium according to the second example embodiment, by using an information processing apparatus 2.

In FIG. 2, the information processing apparatus 2 is provided with an arithmetic apparatus 21, a storage apparatus 22, a communication apparatus 23, a visible light camera 26, and a near-infrared camera 27. The information processing apparatus 2 may be provided with an input apparatus 24 and an output apparatus 25. The information processing apparatus 2 may not be provided with at least one of the input apparatus 24 and the output apparatus 25. In the information processing apparatus 2, the arithmetic apparatus 21, the storage apparatus 22, the communication apparatus 23, the input apparatus 24, the output apparatus 25, the visible light camera 26, and the near-infrared camera 27 may be connected via a data bus 28.

The arithmetic apparatus 21 may include, for example, at least one of a CPU (Central Processing Unit), a GPU (Graphics Processing Unit), a FPGA (Field Programmable Gate Array), a TPU (Tensor Processing Unit), and a quantum processor.

The storage apparatus 22 may include, for example, at least one of a RAM (Random Access Memory), a ROM (Read Only Memory), a hard disk apparatus, a magneto-optical disk apparatus, a SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 is executing the computer program.

The communication apparatus 23 may be configured to communicate with an apparatus external to the authentication apparatus 2 via a not-illustrated network. The communication apparatus 23 may perform wired communication or wireless communication. The wired communication is not limited to communication via a network, but conceptually includes communication via a cable such as, for example, a USB (Universal Serial Bus) cable. The wireless communication is not limited to communication via a network, but conceptually includes short-range wireless communication such as, for example, Bluetooth (registered trademark).

The input apparatus 24 is an apparatus that is configured to receive an input of information to the information processing apparatus 2 from the outside. The input apparatus 24 may include an operating apparatus (e.g., a keyboard, a mouse, a touch panel, etc.) that is operable by an operator of the information processing apparatus 2. The input apparatus 24 may include a recording medium reading apparatus that is configured to read information recorded on a recording medium that is attachable to or detachable from the information processing apparatus 2, such as a USB memory. When information is inputted to the information processing apparatus 2 via the communication apparatus 23 (in other words, when the information processing apparatus 2 acquires information via the communication apparatus 23), the communication apparatus 23 may function as an input apparatus.

The output apparatus 25 is an apparatus that is configured to output information to the outside of the information processing apparatus 2. The output apparatus 25 may output, as the above information, visual information such as characters and images, auditory information such as voice/sound, or tactile information such as vibration. The output apparatus 25 may include, for example, at least one of a display, a speaker, a printer, and a vibration motor. The output apparatus 25 may be configured to output information to a recording medium that is attachable to or detachable from the information processing apparatus 2, such as a USB memory. When the information processing apparatus 2 outputs information via the communication apparatus 23, the communication apparatus 23 may function as an output apparatus.

The visible light camera 26 is a camera including a light receiving element that is configured to receive visible light. The near-infrared camera 27 is a camera including a light receiving element that is configured to receive near-infrared light. The visible light camera 26 and the near-infrared camera 27 may be stored in different housings or in the same housing. Since various existing aspects are applicable to the visible light cameras 26 and the near-infrared cameras 27, a description of details thereof is omitted.

The arithmetic apparatus 21 may include an image acquisition unit 211, a face detection unit 212, an eye detection unit 213, a teary eye determination unit 214, a facial recognition unit 215, an iris recognition unit 216, and an integrated authentication unit 217, as function blocks realized logically or as processing circuits realized physically. At least one of the image acquisition unit 211, the face detection unit 212, the eye detection unit 213, the teary eye determination unit 214, the facial recognition unit 215, the iris recognition unit 216, and the integrated authentication unit 217 may be realized in a mixed form of logical function blocks and physical processing circuits (i.e., hardware). When at least a part of the image acquisition unit 211, the face detection unit 212, the eye detection unit 213, the teary eye determination unit 214, the facial recognition unit 215, the iris recognition unit 216, and the integrated authentication unit 217 is a functional block, at least a part of the image acquisition unit 211, the face detection unit 212, the eye detection unit 213, the teary eye determination unit 214, the facial recognition unit 215, the iris recognition unit 216, and the integrated authentication unit 217 may be realized by the arithmetic apparatus 21 executing a predetermined computer program.

The arithmetic apparatus 21 may acquire (in other words, read) the predetermined computer program from the storage apparatus 22. The arithmetic apparatus 21 may read the predetermined computer program stored on a computer-readable and non-transitory recording medium, by using a not-illustrated recording medium reading apparatus provided in the information processing apparatus 2. The arithmetic apparatus 21 may acquire (in other words, download or read) the predetermined computer program from a not-illustrated apparatus external to the information processing apparatus 2 via the communication apparatus 23. At least one of an optical disk, a magnetic medium, a magneto-optical disk, a semiconductor memory, and any other medium configured to store a program, is used as the recording medium that records therein the predetermined computer program to be executed by the arithmetic apparatus 21.

The image acquisition unit 211 acquires a visible light image including a target person imaged by the visible light camera 26. The image acquisition unit 211 acquires a near-infrared image including the target person imaged by the near-infrared camera 27. As described later, the visible light image is used for facial recognition by the facial recognition unit 215. Therefore, the visible light camera 26 captures images of the target person so as to include an entire face of the target person. As a result, the visible light image includes the face of the target person. Therefore, the visible light image may be referred to as a face image. As described later, the near-infrared image is used for iris recognition by the iris recognition unit 216. Therefore, the near-infrared camera 27 captures images of the target person so as to include at least both eyes of the target person. As a result, the near-infrared image includes both the eyes of the target person. Therefore, the near-infrared image may be referred to as an eye image. As described later, since the target person is a target person of the facial recognition by the facial recognition unit 215 and the iris recognition by the iris recognition unit 216, the target person may be referred to as an authentication subject.

The face detection unit 212 detects a face area of the target person included in the visible light image. A detection result of the face detection unit 212 may be outputted to at least one of the eye detection unit 213 and the facial recognition unit 215. Since existing techniques/technologies are applicable to a method of detecting the face area of the target person, a description of details thereof is omitted.

The eye detection unit 213 detects an eye area of the target person included in the near-infrared image. The eye detection unit 213 may detect the eye area of the target person included in the near-infrared image, based on the detection result of the face detection unit 212. For example, in a case where a relation is known between an imaging range of the visible light camera 26 and an imaging range of the near-infrared camera 27, it is possible to estimate the position of the eyes of the target person in the near-infrared image, based on the face area of the target person included in the visible light image (i.e., the face area detected by the face detection unit 212). Therefore, by the eye detection unit 213 referring to the detection result of the face detection unit 212, it is possible to relatively easily detect the eye area of the target person included in the near-infrared image. A detection result of the eye detection unit 213 may be outputted to at least one of the teary eye determination unit 214 and the iris recognition unit 216.

The teary eye determination unit 214 performs teary eye determination of determining whether or not the target person included in the near-infrared image has teary eyes. The teary eye determination unit 214 may perform the teary eye determination, based on the detection result of the eye detection unit 213. The teary eye determination unit 214 may perform the teary eye determination by using an arithmetic model that outputs a result from determination of whether or not the target person included in the near-infrared image has teary eyes, when the near-infrared image is inputted. An example of such an arithmetic model is an arithmetic model using a neural network (e.g., CNN: Convolutional Neural Network). The teary eye determination unit 214 may perform the teary eye determination by using visible light image, in addition to or instead of the near-infrared image. A determination result of the teary eye determination unit 214 is outputted to the integrated authentication unit 217.

The facial recognition unit 215 performs facial recognition by using the visible light image. The facial recognition unit 215 may identify the face area of the target person included in the visible light image, based on the detection result of the face detection unit 212. For example, the facial recognition unit 215 may extract features related to the face area of the target person included in the visible light image, from the visible light image. The facial recognition unit 215 may calculate a face matching score by comparing/matching the extracted features with features included in feature data 221.

The iris recognition unit 216 performs iris recognition by using the near-infrared image. The iris recognition unit 216 may identify the eye area of the target person included in the near-infrared image, based on the detection result of the eye detection unit 213. For example, the iris recognition unit 216 may extract features related to the eye area of the target person included in the near-infrared image, from the near-infrared image. The iris recognition unit 216 may calculate an iris matching score by comparing/matching the extracted features with features included in the feature data 221.

The integrated authentication unit 217 may calculate an integrated score, for example, based on the face matching score calculated by the facial recognition unit 215 and the iris matching score calculated by the iris recognition unit 216. The integrated authentication unit 217 may perform identity determination/verification of determining whether or not the target person (i.e., a person who is the target person of the facial recognition and is also the target person of the iris recognition) is a registered person himself/herself, by comparing the integrated score with a threshold. The integrated authentication unit 217 may determine that the target person is the registered person himself/herself, when the integrated score is greater than or equal to the threshold. The integrated authentication unit 217 may determine that the target person is not the registered person, when the integrated score is less than the threshold. The integrated authentication unit 217 corresponds to an example of the determination unit 13 in the first example embodiment described above.

Especially in the present example embodiment, the integrated authentication unit 217 performs the above-mentioned identity determination, based on the determination result of the teary eye determination unit 214. When the teary eye determination unit 214 determines that the target person has teary eyes, the integrated authentication unit 217 may reduce a weight of the iris matching score (i.e., may lower the priority of the iris recognition) when calculating the integrated score. With this configuration, even when the iris matching score is relatively low due to the target person having teary eyes, the target person is easily determined to be the registered person himself/herself. The integrated authentication unit 217 may increase a weight of the face matching score, instead of or in addition to reducing the weight of the iris matching score. In this case, the priority of the iris recognition relative to the facial recognition is relatively reduced. When the teary eye determination unit 214 determines that the target person does not have teary eyes, the integrated authentication unit 217 may not lower the priority of the iris recognition.

The facial recognition unit 215 may determine that the facial recognition is successful when the face matching score is greater than or equal to a facial recognition threshold. The facial recognition unit 215 may determine that the facial recognition is failed when the face matching score is less than the facial recognition threshold. Similarly, the iris recognition unit 216 may determine that the iris recognition is successful when the iris matching score is greater than or equal to an iris recognition threshold. The iris recognition unit 216 may determine that the iris recognition is failed when the iris matching score is less than the iris recognition threshold. The integrated authentication unit 217 may determine that the target person is the registered person himself/herself, when the facial recognition unit 215 determines that the facial recognition is successful and the iris recognition unit 216 determines that the iris recognition is successful. Here, in a case where the teary eye determination unit 214 determines that the target person has teary eyes, the integrated authentication unit 217 may determine that the target person is the registered person himself/herself when the facial recognition unit 215 determines that the facial recognition is successful, even though the iris recognition unit 216 determines that the iris recognition is failed.

### Technical Effect

In the information processing apparatus 2, when the teary eye determination unit 214 determines that the target person has teary eyes, the integrated authentication unit 217 performs the above-mentioned identity determination by lowering the priority of the iris recognition (e.g., by reducing the weight of the iris matching score when calculating the integrated score). Therefore, according to the information processing apparatus 2, even when the target person has teary eyes, the identity determination may be performed appropriately.

### Modified Example

The teary eye determination unit 214 may output the determination result to at least one of the facial recognition unit 215 and the iris recognition unit 216. When the teary eye determination unit 214 determines that the target person has teary eyes, the facial recognition unit 215 may change a parameter related to the facial recognition. The parameter related to the facial recognition may include at least one of the number of execution times of the facial recognition and the facial recognition threshold related to the facial recognition. When the teary eye determination unit 214 determines that the target person has teary eyes, the facial recognition unit 215 may increase the number of execution times of the facial recognition. When the teary eye determination unit 214 determines that the target person has teary eyes, the facial recognition unit 215 may raise the facial recognition threshold.

When the teary eye determination unit 214 determines that the target person has teary eyes, the iris recognition unit 216 may change a parameter related to the iris recognition. The parameter related to the iris recognition may include at least one of the number of execution times of the iris recognition and the iris recognition threshold related to the iris recognition. When the teary eye determination unit 214 determines that the target person has teary eyes, the iris recognition unit 216 may increase the number of execution times of the iris recognition. When the teary eye determination unit 214 determines that the target person has teary eyes, the iris recognition unit 216 may lower the iris recognition threshold.

When the teary eye determination unit 214 determines that the target person has teary eyes, the iris recognition unit 216 may perform preprocessing on the near-infrared image used for the iris recognition. The iris recognition unit 216 may perform the iris recognition by using the preprocessed near-infrared image. The preprocessing may include, for example, emphasizing an area corresponding to the iris of the target person in the near-infrared image. The processing of emphasizing the area corresponding to the iris, may include at least one of: correcting brightness of the near-infrared image to increase brightness of the area corresponding to the iris; and correcting contrast of the near-infrared image to increase contrast of the area corresponding to the iris. The processing of emphasizing the area corresponding to the iris may also be referred to as processing of increasing a weight of the area corresponding to the iris.

The iris recognition unit 216 may have a plurality of modes for the iris recognition. The plurality of modes may include a first mode for performing the iris recognition by using features related to all of the iris of the target person, and a second mode for performing the iris recognition by using features related to a part of the iris of the target person. When the teary eye determination unit 214 determines that the target person has teary eyes, the iris recognition unit 216 may perform the iris recognition in the second mode. When the teary eye determination unit 214 determines that the target person does not have teary eyes, the iris recognition unit 216 may perform the iris recognition in the first mode.

### Third Example Embodiment

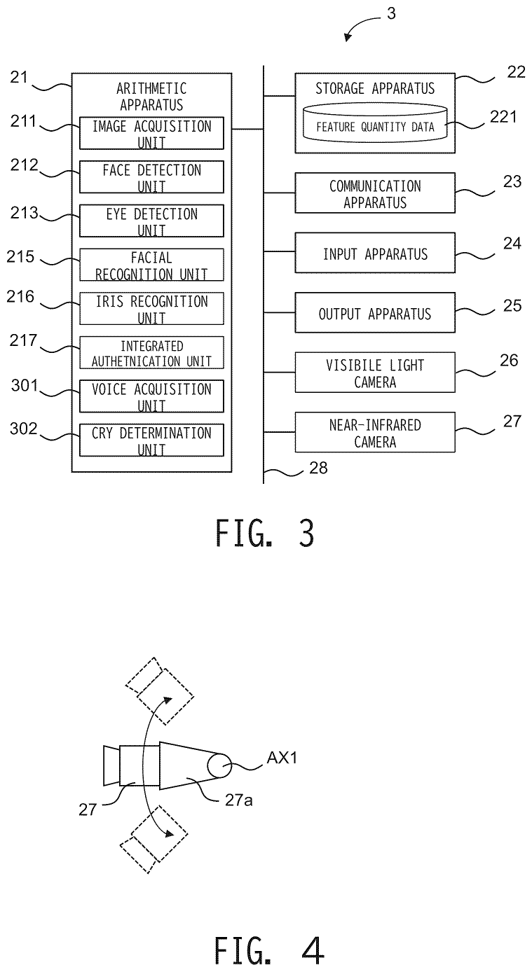

An information processing apparatus, an information processing method, and a recording medium according to a third example embodiment will be described with reference to FIG. 3. The following describes the information processing apparatus, information processing method, and recording medium according to the third example embodiment, by using an information processing apparatus 3. In the third example embodiment, a description overlapping with that of the second example embodiment described above is omitted as appropriate, and the same parts in the drawing carry the same reference numerals.

In FIG. 3, the arithmetic apparatus 21 of the information processing apparatus 3 includes a voice acquisition unit 301 and a cry determination unit 302, as function blocks realized logically or as processing circuits realized physically. When the information processing apparatus 3 is compared with the information processing apparatus 2 in the second example embodiment described above, the information processing apparatus 3 differs from the information processing apparatus 2 in that it includes the voice acquisition unit 301 and the cry determination unit 302, but does not include the teary eye determination unit 214. That is, it can be said that the information processing apparatus 3 includes the voice acquisition unit 301 and the cry determination unit 302, instead of the teary eye determination unit 214.

The input apparatus 24 includes a microphone for collecting/recording voice of the target person. The voice acquisition unit 301 acquires voice information about the voice of the target person collected/recorded by the microphone. The voice information may be analog information or digital information. In a case where the voice information is digital information, a file format of the voice information is arbitrary.

The cry determination unit 302 performs cry determination of determining whether or not the target person is crying, based on the voice information acquired by the voice acquisition unit 301. The cry determination unit 302 may perform the cry determination by using an arithmetic model that outputs a result from determination of whether or not the target person is crying, when the voice information is inputted. An example of such an arithmetic model is an arithmetic model using a neural network (e.g., CNN). A determination result of the cry determination unit 302 is outputted to the integrated authentication unit 217.

The integrated authentication unit 217 performs the identity determination, based on the determination result of the cry determination unit 302. When the cry determination unit 302 determines that the target person is crying, the integrated authentication unit 217 may reduce the weight of the iris matching score (i.e., may lower the priority of the iris recognition) when calculating the integrated score. With this configuration, even when the iris matching score is relatively low due to the target person crying, the target person is easily determined to be the registered person himself/herself. The integrated authentication unit 217 may increase the weight of the face matching score, instead of or in addition to reducing the weight of the iris matching score. In this case, the priority of the iris recognition relative to the facial recognition is relatively reduced. When the crying detection unit 302 determines that the target person is not crying, the integrated authentication unit 217 may not lower the priority of the iris recognition.

The facial recognition unit 215 may determine that the facial recognition is successful when the face matching score is greater than or equal to the facial recognition threshold. The facial recognition unit 215 may determine that the facial recognition is failed when the face matching score is less than the facial recognition threshold. Similarly, the iris recognition unit 216 may determine that the iris recognition is successful when the iris matching score is greater than or equal to the iris recognition threshold. The iris recognition unit 216 may determine that the iris recognition is failed when the iris matching score is less than the iris recognition threshold. The integrated authentication unit 217 may determine that the target person is the registered person himself/herself, when the facial recognition unit 215 determines that the facial recognition is successful and the iris recognition unit 216 determines that the iris recognition is successful. Here, in a case where the cry determination unit 302 determines that the target person is crying, the integrated authentication unit 217 may determine that the target person is the registered person himself/herself when the facial recognition unit 215 determines that the facial recognition is successful, even though the iris recognition unit 216 determines that the iris recognition is failed.

### Technical Effect

In the information processing apparatus 3, when the cry determination unit 302 determines that the target person is crying, the integrated authentication unit 217 performs the above-mentioned identity determination by lowering the priority of the iris recognition (e.g., by reducing the weight of the iris matching score when calculating the integrated score). Therefore, according to the information processing apparatus 3, even when the target person is crying, the identity determination may be performed appropriately.

### Modified Example

The cry determination unit 302 may output the determination result to at least one of the facial recognition unit 215 and the iris recognition unit 216. When the cry determination unit 302 determines that the target person is crying, the facial recognition unit 215 may change a parameter related to the facial recognition. The parameter related to the facial recognition may include at least one of the number of execution times of the facial recognition and the facial recognition threshold related to the facial recognition. When the cry determination unit 302 determines that the target person is crying, the facial recognition unit 215 may increase the number of execution times of the facial recognition. When the cry determination unit 302 determines that the target person is crying, the facial recognition unit 215 may raise the facial recognition threshold.

When the cry determination unit 302 determines that the target person is crying, the iris recognition unit 216 may change a parameter related to the iris recognition. The parameter related to the iris recognition may include at least one of the number of execution times of the iris recognition and the iris recognition threshold related to the iris recognition. When the cry determination unit 302 determines that the target person is crying, the iris recognition unit 216 may increase the number of execution times of the iris recognition. When the cry determination unit 302 determines that the target person is crying, the iris recognition unit 216 may lower the iris recognition threshold.

When the cry determination unit 302 determines that the target person is crying, the iris recognition unit 216 may perform preprocessing on the near-infrared image used for the iris recognition. The iris recognition unit 216 may perform the iris recognition by using the preprocessed near-infrared image. The preprocessing may include, for example, emphasizing an area corresponding to the iris of the target person in the near-infrared image. The processing of emphasizing the area corresponding to the iris, may include at least one of: correcting brightness of the near-infrared image to increase brightness of the area corresponding to the iris; and correcting contrast of the near-infrared image to increase contrast of the area corresponding to the iris. The processing of emphasizing the area corresponding to the iris may also be referred to as processing of increasing a weight of the area corresponding to the iris.

The iris recognition unit 216 may have a plurality of modes for the iris recognition. The plurality of modes may include a first mode for performing the iris recognition by using features related to all of the iris of the target person, and a second mode for performing the iris recognition by using features related to a part of the iris of the target person. When the cry determination unit 302 determines that the target person is crying, the iris recognition unit 216 may perform the iris recognition in the second mode. When the cry determination unit 302 determines that the target person is not crying, the iris recognition unit 216 may perform the iris recognition in the first mode.

For example, the face detection unit 212 may estimate the age of the target person included in the visible light image. The cry determination unit 302 may determine whether or not the target person is crying, when the estimated age is less than or equal to a predetermined value. The predetermined value is a value for determining whether or not the cry determination unit 302 performs the cry determination. The predetermined value may be set as an upper limit of the age at which the target person is likely to start crying due to a failure in biometric authentication resulting in a failure in entry (e.g., an automatic door does not open).

As illustrated in FIG. 4, in a case where the near-infrared camera 27 is supported by a support member 27a that is rotatable around a rotation axis AX1, the imaging range of the near-infrared camera 27 may be changed by rotating the support member 27a around the rotation axis AX1. In this case, the arithmetic apparatus 21 may estimate height of the target person, based on an angle of rotation of the support member 27a around the rotation axis AX1. Alternatively, as illustrated in FIG. 5, in a case where the imaging range of the near-infrared camera 27 is changed by rotating a mirror M, which guides near-infrared light to the near-infrared camera 27, around a rotation axis AX2, the arithmetic apparatus 21 may estimate the height of the target person, based on an angle of rotation of the mirror M around the rotation axis AX2. The facial recognition unit 212 may estimate the age of the target person, based on the estimated height, in addition to the visible light image.

The face detection unit 212 may detect a white-of-eye (sclera) area corresponding to a white part of the eye area of the target person included in the visible light image. The face detection unit 212 may detect a bloodshot eye area, which looks red due to a bloodshot eye of the target person, from the white-of-eye area. The cry determination unit 302 may lower a threshold related to the cry determination (i.e., make it easier to determine that the target person is crying) when the detected white-of-eye area includes a predetermined amount or more of detected bloodshot eye areas. The eye detection unit 213 may detect the white-of-eye area from the eye area of the target person included in the near-infrared image. The eye detection unit 213 may detect the bloodshot area from the white-of-eye area. In this case, the eye detection unit 213 may detect at least one of the white-of-eye area and the bloodshot eye area, by using an arithmetic model that outputs at least one of the white-of-eye area and the bloodshot eye area, when a near-infrared image is inputted. An example of such an arithmetic model is an arithmetic model using a neural network (e.g., CNN). Such an arithmetic model may be constructed by learning/training the model with the near-infrared image including bloodshot eyes. Since the arithmetic model is used to detect at least one of the white-of-eye area and the bloodshot eye area, the arithmetic model may also be referred to as a detector. The cry determination unit 302 may change the threshold related to the cry determination, based on the white-of-eye area and the bloodshot eye area detected by the eye detection unit 213.

The iris recognition unit 216 may determine that the iris recognition is failed when the iris matching score is less than the iris recognition threshold related to the iris recognition. The cry determination unit 302 may perform the cry determination only when the iris recognition of the target person by the iris recognition unit 216 is failed.

### Fourth Example Embodiment

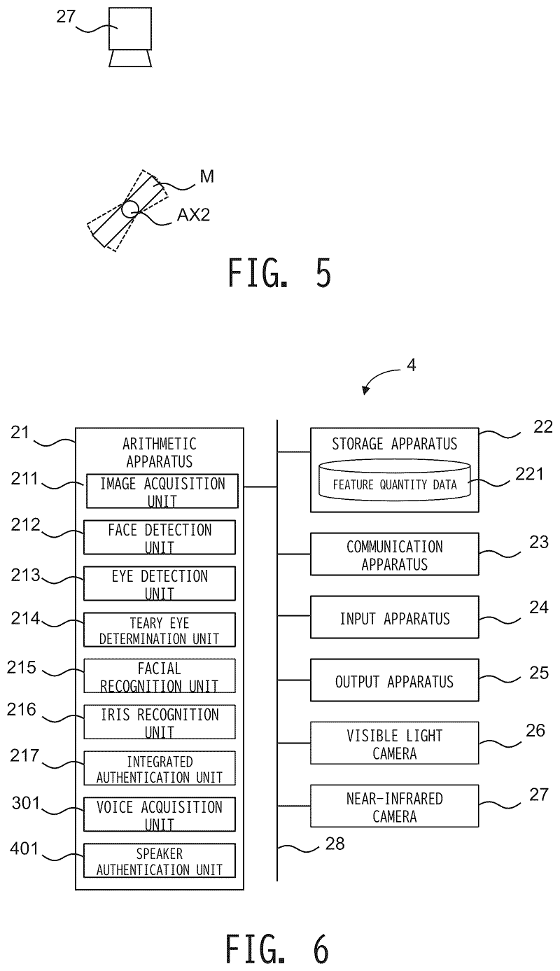

An information processing apparatus, an information processing method, and a recording medium according to a fourth example embodiment will be described with reference to FIG. 6. The following describes the information processing apparatus, information processing method, and recording medium according to the fourth example embodiment, by using an information processing apparatus 4. In the fourth example embodiment, a description overlapping with those of the second and third example embodiments described above is omitted as appropriate, and the same parts in the drawing carry the same reference numerals.

In FIG. 6, the arithmetic apparatus 21 of the information processing apparatus 4 includes a speaker authentication unit 401, as a function block realized logically or as a processing circuit realized physically. When the information processing apparatus 4 is compared with the information processing apparatus 2 in the second example embodiment described above, the information processing apparatus 4 differs from the information processing apparatus 2 in that it includes the voice acquisition unit 301 and the speaker authentication unit 401.

In the information processing apparatus 4, the determination result of the teary eye determination unit 214 is outputted to the speaker authentication unit 401. When the teary eye determination unit 214 determines that the target person has teary eyes, the speaker authentication unit 401 may estimate that the target person is crying. In this case, the speaker authentication unit 401 may perform speaker authentication by using the voice information acquired by the voice acquisition unit 301. In this case, the speaker authentication unit 401 may perform the speaker authentication by using a cry of the target person included in the voice information. Since various existing methods are applicable to the speaker authentication, a description of details thereof is omitted. When the teary eye determination unit 214 determines that the target person does not have teary eyes, the speaker authentication unit 401 may not perform the speaker authentication.

The face detection unit 212 may estimate the age of the target person included in the visible light image. As illustrated in FIG. 4, in a case where the near-infrared camera 27 is supported by the support member 27a that is rotatable around the rotation axis AX1, the imaging range of the near-infrared camera 27 may be changed by rotating the support member 27a around the rotation axis AX1. In this case, the arithmetic apparatus 21 may estimate the height of the target person, based on the angle of rotation of the support member 27a around the rotation axis AX1. Alternatively, as illustrated in FIG. 5, in a case where the imaging range of the near-infrared camera 27 is changed by rotating the mirror M, which guides near-infrared light to the near-infrared camera 27, around the rotation axis AX2, the arithmetic apparatus 21 may estimate the height of the target person, based on the angle of rotation of the mirror M around the rotation axis AX2. The facial recognition unit 212 may estimate the age of the target person, based on the estimated height, in addition to the visible light image. When the teary eye determination unit 214 determines that the target person has teary eyes, the speaker authentication unit 401 may perform the speaker authentication by using the cry of the target person included in the voice information, only when the estimated age is less than or equal to a predetermined value.

When the speaker authentication unit 401 estimates that the target person is crying (in other words, when the teary eye determination unit 214 determines that the target person has teary eyes), the speaker authentication unit 401 may instruct the target person to speak/emit the voice via the output apparatus 25. In this case, the voice acquisition unit 301 may acquire the voice information about the voice of the target person (i.e., the voice emitted in accordance with the above instruction) collected/recorded by the microphone included in the input apparatus 24. The speaker authentication unit 401 may perform the speaker authentication by using the acquired voice information.

A result of the speaker authentication by the speaker authentication unit 401 is outputted to the integrated authentication unit 217. When the speaker authentication is performed by the speaker authentication unit 401 (in other words, when the teary eye determination unit 214 determines that the target person has teary eyes), the integrated authentication unit 217 may perform the identity determination by integrating the result of the facial recognition by the facial recognition unit 215 and the result of the speaker authentication by the speaker authentication unit 401 (e.g., by calculating an integrated score).

When the speaker authentication is not performed by the speaker authentication unit 401 (in other words, when the teary eye determination unit 214 determines that the target person does not have teary eyes), the integrated authentication unit 217 may perform the identity determination by integrating the result of the facial recognition by the facial recognition unit 215 and the result of the iris recognition by the iris recognition unit 216.

When the speaker authentication is performed by the speaker authentication unit 401 (in other words, when the teary eye determination unit 214 determines that the target person has teary eyes), the integrated authentication unit 217 may perform the identity determination by integrating the result of the facial recognition by the facial recognition unit 215, the result of the iris recognition by the iris recognition unit 216, and the result of the speaker authentication by the speaker authentication unit 401.

### Technical Effect

In the information processing apparatus 4, when the teary eye determination unit 214 determines that the target person has teary eyes, the speaker authentication unit 401 performs the speaker authentication. When the speaker authentication is performed by the speaker authentication unit 401, the integrated authentication unit 217 performs the identity determination, based on the result of the facial recognition by the facial recognition unit 215 and the result of the speaker authentication by the speaker authentication unit 401. Therefore, according to the information processing apparatus 4, even when the iris recognition by the iris recognition unit 216 is difficult due to the target person having teary eyes or crying, the identity determination may be performed appropriately.

### Fifth Example Embodiment

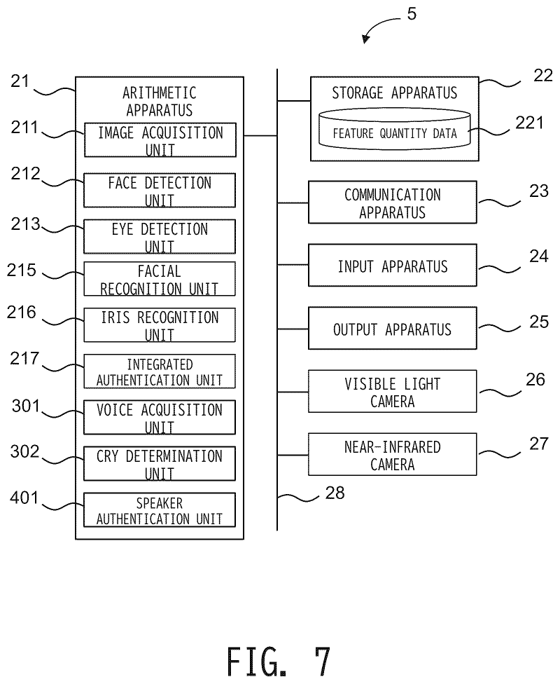

An information processing apparatus, an information processing method, and a recording medium according to a fifth example embodiment will be described with reference to FIG. 7. The following describes the information processing apparatus, information processing method, and recording medium according to the fifth example embodiment, by using an information processing apparatus 5. In the fifth example embodiment, a description overlapping with those of the second to fourth example embodiments described above is omitted as appropriate, and the same parts in the drawing carry the same reference numerals.

When the information processing apparatus 5 is compared with the information processing apparatus 4 in the fourth example embodiment described above (see FIG. 6), the information processing apparatus 5 differs from the information processing apparatus 4 in that it includes the cry determination unit 302, but does not include the teary eye determination unit 214. That is, in the information processing apparatus 5, the cry determination of determining whether or not the target person is crying, may be performed, but the teary eye determination of determining whether or not the target person has teary eyes, may not be performed.

The input apparatus 24 includes a microphone for collecting/recording the voice of the target person. The voice acquisition unit 301 acquires the voice information about the voice of the target person collected/recorded by the microphone. The cry determination unit 302 performs the cry determination of determining whether or not the target person is crying, based on the voice information acquired by the voice acquisition unit 301.

When the cry determination unit 302 determines that the target person is crying, the speaker authentication unit 401 may perform the speaker authentication by using the voice information acquired by the voice acquisition unit 301. In this case, the speaker authentication unit 401 may perform the speaker authentication by using the cry of the target person included in the voice information. On the other hand, when the cry determination unit 302 determines that the target person is not crying, the speaker authentication unit 401 may not perform the speaker authentication.

The face detection unit 212 may estimate the age of the target person included in the visible light image. As illustrated in FIG. 4, in a case where the near-infrared camera 27 is supported by the support member 27a that is rotatable around the rotation axis AX1, the imaging range of the near-infrared camera 27 may be changed by rotating the support member 27a around the rotation axis AX1. In this case, the arithmetic apparatus 21 may estimate the height of the target person, based on the angle of rotation of the support member 27a around the rotation axis AX1. Alternatively, as illustrated in FIG. 5, in a case where the imaging range of the near-infrared camera 27 is changed by rotating the mirror M, which guides near-infrared light to the near-infrared camera 27, around the rotation axis AX2, the arithmetic apparatus 21 may estimate the height of the target person, based on the angle of rotation of the mirror M around the rotation axis AX2. The facial recognition unit 212 may estimate the age of the target person, based on the estimated height, in addition to the visible light image. When the cry determination unit 302 determines that the target person is crying, the speaker authentication unit 401 may perform the speaker authentication by using the cry of the target person included in the voice information, only when the estimated age is less than or equal to a predetermined value.

When the cry determination unit 302 determines that the target person is crying, the speaker authentication unit 401 may instruct the target person to speak/emit the voice via the output apparatus 25. In this case, the voice acquisition unit 301 may acquire the voice information about the voice of the target person (i.e., the voice emitted in accordance with the above instruction) collected/recorded by the microphone included in the input apparatus 24. The speaker authentication unit 401 may perform the speaker authentication by using the acquired voice information.

The result of the speaker authentication by the speaker authentication unit 401 is outputted to the integrated authentication unit 217. When the speaker authentication is performed by the speaker authentication unit 401 (in other words, when the cry determination unit 302 determines that the target person is crying), the integrated authentication unit 217 may perform the identity determination by integrating the result of the facial recognition by the facial recognition unit 215 and the result of the speaker authentication by the speaker authentication unit 401 (e.g., by calculating an integrated score).

When the speaker authentication is not performed by the speaker authentication unit 401 (in other words, when the crying detection unit 302 determines that the target person is not crying), the integrated authentication unit 217 may perform the identity determination by integrating the result of the facial recognition by the facial recognition unit 215 and the result of the iris recognition by the iris recognition unit 216.

When the speaker authentication is performed by the speaker authentication unit 401 (in other words, when the crying detection unit 302 determines that the target person is crying), the integrated authentication unit 217 may perform the identity determination by integrating the result of the facial recognition by the facial recognition unit 215, the result of the iris recognition by the iris recognition unit 216, and the result of the speaker authentication by the speaker authentication unit 401.

### Technical Effect

In the information processing apparatus 5, when the cry determination unit 302 determines that the target person is crying, the speaker authentication unit 401 performs the speaker authentication. When the speaker authentication is performed by the speaker authentication unit 401, the integrated authentication unit 217 performs the identity determination, based on the result of the facial recognition by the facial recognition unit 215 and the result of the speaker authentication by the speaker authentication unit 401. Therefore, according to the information processing apparatus 5, even when the iris recognition by the iris recognition unit 216 is difficult due to the target person crying, the identity determination may be performed appropriately.

### Supplementary Notes

With respect to the example embodiment described above, the following Supplementary Notes are further disclosed.

### Supplementary Note 1

An information processing apparatus including:

a facial recognition unit that performs facial recognition by using a face image including a face of a target;

an iris recognition unit that performs iris recognition by using an eye image including an iris of the target; and

a determination unit that performs identity determination of determining whether the target is a registered person himself/herself, based on a result of the facial recognition and a result of the iris recognition, wherein

the determination unit lowers priority of the iris recognition and performs the identity determination, in a case where it is estimated by using information about the target that the target is in a state of at least one of crying and having teary eyes.

### Supplementary Note 2

The information processing apparatus according to Supplementary Note 1, wherein the information about the target includes at least one of the face image and the eye image.

### Supplementary Note 3

The information processing apparatus according to Supplementary Note 1 or 2, wherein at least one of the facial recognition unit and the iris recognition unit changes a parameter of the facial recognition or the iris recognition, in response to an estimation that the target is in a state of at least one of crying and having teary eyes.

### Supplementary Note 4

The information processing apparatus according to any one of Supplementary Notes 1 to 3, wherein at least one of the facial recognition unit and the iris recognition unit changes a number of times of the facial recognition or the iris recognition, in response to an estimation that the target is in a state of at least one of crying and having teary eyes.

### Supplementary Note 5

The information processing apparatus according to any one of Supplementary Notes 1 to 4, wherein

the determination unit performs the identity determination after integrating the result of the facial recognition and the result of the iris recognition, and

the determination unit changes a weight when integrating the result of the facial recognition and the result of the iris recognition, in response to an estimation that the target is in a state of at least one of crying and having teary eyes.

### Supplementary Note 6

The information processing apparatus according to any one of Supplementary Notes 1 to 5, wherein the iris recognition unit performs the iris recognition after preprocessing the eye image, in response to an estimation that the target is in a state of at least one of crying and having teary eyes.

### Supplementary Note 7

The information processing apparatus according to any one of Supplementary Notes 1 to 6, wherein the iris recognition unit performs the iris recognition after increasing a weight of an area corresponding to the iris, in the eye image, in response to an estimation that the target is in a state of at least one of crying and having teary eyes.

### Supplementary Note 8

The information processing apparatus according to any one of Supplementary Notes 1 to 7, including: an estimation unit that estimates that the target is crying, by using on the information about the target, wherein

the estimation unit lowers a threshold for estimating that the target is crying, in a case where use of at least one of the face image and the eye image reveals that a white-of-eye area of the target includes a predetermined amount or more of bloodshot eye areas.

### Supplementary Note 9

The information processing apparatus according to any one of Supplementary Notes 1 to 8, wherein

the information about the target includes a voice of the target inputted via a microphone, and

the information processing apparatus includes a speaker authentication unit that performs speaker authentication by using the voice of the target, in response to an estimation that the target person is crying.

### Supplementary Note 10

The information processing apparatus according to Supplementary Note 9, including an instruction unit that instructs the target to speak/emit a voice, in response to an estimation that the target person is crying.

### Supplementary Note 11

The information processing apparatus according to Supplementary Note 9 or 10, wherein the speaker authentication unit performs the speaker authentication by using a cry of the target serving as the voice of the target.

### Supplementary Note 12

The information processing apparatus according to Supplementary Note 11, wherein the speaker authentication unit performs the speaker authentication by using the cry of the target person serving as the voice of the target, in a case where age of the target is less than or equal to a predetermined age.

### Supplementary Note 13

The information processing apparatus according to any one of Supplementary Notes 1 to 12, including an estimation unit that estimates that the target is crying, by using the information about the target, in response to a failure in the iris recognition of the target.

### Supplementary Note 14

The information processing apparatus according to any one of Supplementary Notes 9 to 12, wherein, in a case where the speaker authentication is performed, the determination unit performs the identity determination after integrating the result of the facial recognition and the result of the speaker authentication.

### Supplementary Note 15

An information processing method including:

performing facial recognition by using a face image including a face of a target;

performing iris recognition by using an eye image including an iris of the target;

performing identity determination of determining whether the target is a registered person himself/herself, based on a result of the facial recognition and a result of the iris recognition; and

lowering priority of the iris recognition and performing the identity determination, in a case where it is estimated by using information about the target that the target is in a state of at least one of crying and having teary eyes.

### Supplementary Note 16

A recording medium on which a computer program that allows a computer to execute an information processing method is recorded, the information processing method including:

performing facial recognition by using a face image including a face of a target;

performing iris recognition by using an eye image including an iris of the target;

performing identity determination of determining whether the target is a registered person himself/herself, based on a result of the facial recognition and a result of the iris recognition; and

lowering priority of the iris recognition and performing the identity determination, in a case where it is estimated by using information about the target that the target is in a state of at least one of crying and having teary eyes.

This disclosure is not limited to the example embodiments described above, but is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1, 2, 3, 4 Information processing apparatus
11, 215 Facial recognition unit
12, 216 Iris recognition unit
13 Determination unit
21 Arithmetic apparatus
26 Visible light camera
27 Near-infrared camera
211 Image acquisition unit
212 Face detection unit
213 Eye detection unit
214 Teary eye detection unit
217: Integrated authentication unit

What is claimed is:

1. An information processing apparatus comprising:
at least one memory that is configured to store instructions; and
at least one processor that is configured to execute the instructions to:
perform facial recognition by using a face image including a face of a target;
an perform iris recognition by using an eye image including an iris of the target;
perform identity determination of determining whether the target is a registered person himself/herself, based on a result of the facial recognition and a result of the iris recognition
lower priority of the iris recognition and performs the identity determination, in a case where it is estimated by using information about the target that the target is in a state of at least one of crying and having teary eyes; and
estimate that the target is crying, by using the information about the target, in response to a failure in the iris recognition of the target.

2. The information processing apparatus according to claim 1, wherein the information about the target includes at least one of the face image and the eye image.

3. The information processing apparatus according to claim 1, wherein the at least one processor is configured to execute the instructions to change a parameter of the facial recognition or the iris recognition, in response to an estimation that the target is in a state of at least one of crying and having teary eyes.

4. The information processing apparatus according to claim 1, wherein the at least one processor is configured to execute the instructions to changes a number of times of the facial recognition or the iris recognition, in response to an estimation that the target is in a state of at least one of crying and having teary eyes.

5. The information processing apparatus according to claim 1, wherein the at least one processor is configured to execute the instructions to:
perform the identity determination after integrating the result of the facial recognition and the result of the iris recognition, and
change a weight when integrating the result of the facial recognition and the result of the iris recognition, in response to an estimation that the target is in a state of at least one of crying and having teary eyes.

6. The information processing apparatus according to claim 1, wherein the at least one processor is configured to execute the instructions to perform the iris recognition after preprocessing the eye image, in response to an estimation that the target is in a state of at least one of crying and having teary eyes.

7. The information processing apparatus according to claim 1, wherein the at least one processor is configured to execute the instructions to perform the iris recognition after increasing a weight of an area corresponding to the iris, in the eye image, in response to an estimation that the target is in a state of at least one of crying and having teary eyes.

8. The information processing apparatus according to claim 1, the at least one processor is configured to execute the instructions to
estimate that the target is crying, by using on the information about the target; and
lower a threshold for estimating that the target is crying, in a case where use of at least one of the face image and the eye image reveals that a white-of-eye area of the target includes a predetermined amount or more of bloodshot eye areas.

9. The information processing apparatus according to claim 1, wherein
the information about the target includes a voice of the target inputted via a microphone, and
the at least one processor is configured to execute the instructions to perform speaker authentication by using the voice of the target, in response to an estimation that the target person is crying.

10. The information processing apparatus according to claim 9, wherein the at least one processor is configured to execute the instructions to instruct the target to speak/emit a voice, in response to an estimation that the target person is crying.

11. The information processing apparatus according to claim 9, wherein the at least one processor is configured to execute the instructions to perform the speaker authentication by using a cry of the target serving as the voice of the target.

12. The information processing apparatus according to

11, wherein the at least one processor is configured to execute the instructions to performs the speaker authentication by using the cry of the target person serving as the voice of the target, in a case where age of the target is less than or equal to a predetermined age.

13. (canceled)

14. The information processing apparatus according to claim 9, wherein, in a case where the speaker authentication is performed, the at least one processor is configured to execute the instructions to performs the identity determination after integrating the result of the facial recognition and the result of the speaker authentication.

15. An information processing method comprising:
performing facial recognition by using a face image including a face of a target;
performing iris recognition by using an eye image including an iris of the target;
performing identity determination of determining whether the target is a registered person himself/herself, based on a result of the facial recognition and a result of the iris recognition;
lowering priority of the iris recognition and performing the identity determination, in a case where it is estimated by using information about the target that the target is in a state of at least one of crying and having teary eyes; and
estimating that the target is crying, by using the information about the target, in response to a failure in the iris recognition of the target.

16. A non-transitory recording medium on which a computer program that allows a computer to execute an information processing method is recorded, the information processing method including:
performing facial recognition by using a face image including a face of a target;
performing iris recognition by using an eye image including an iris of the target;
performing identity determination of determining whether the target is a registered person himself/herself, based on a result of the facial recognition and a result of the iris recognition;
lowering priority of the iris recognition and performing the identity determination, in a case where it is estimated by using information about the target that the target is in a state of at least one of crying and having teary eyes; and
estimating that the target is crying, by using the information about the target, in response to a failure in the iris recognition of the target.
